(19) United States
(12) Patent Application Publication
(10) Pub. No.: US 2015/0263332 A1
(43) Pub. Date: Sep. 17, 2015

(54) HEAT TREATMENT DEVICE FOR MATERIAL IN POWDER FORM AND CORRESPONDING HEAT TREATMENT METHOD

(71) Applicant: RENAULT S.A.S., Boulogne-Billancourt (FR)

(72) Inventors: Marlene Rey, Veurey-Voroize (FR); Philippe Desbois, Saint-Andre-le-Gaz (FR); Cedric Haon, Grenoble (FR); Sebastien Launois, Grenoble (FR)

(73) Assignee: RENAULT S.A.S., Boulogne-Billancourt (FR)

(21) Appl. No.: 14/433,097

(22) PCT Filed: Oct. 2, 2013
(86) PCT No.: PCT/FR2013/052345

§ 371 Date: Apr. 2, 2015

(30) Foreign Application Priority Data
Oct. 4, 2012 (FR) 1259411

(51) Int. Cl. H01M 4/04; C04B 41/00

(52) U.S. Cl. CPC H01M 4/0471; C04B 41/0072; C04B 41/0081

(57) ABSTRACT

A heat treatment device for a material in powder form, including a heat treatment furnace including a heating zone and a quenching tank. The quenching tank includes a container at least partially filled with a plurality of precooled solid elements, and the heat treatment furnace is mounted in a mobile manner to allow the content of the heat treatment furnace to be transferred to the quenching tank. A corresponding heat treatment method, for example, can implement manufacture of lamellar lithium manganese nickel magnesium oxide.

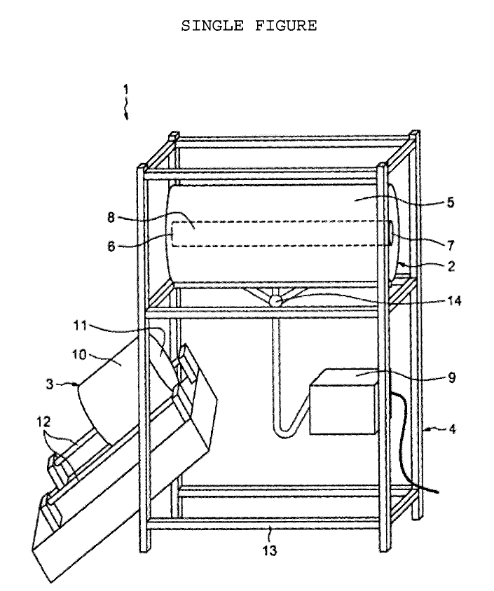

The present invention relates to heat treatment devices and, more particularly, to heat treatment devices for materials in powder form.

There are two broad applications for heat treatment devices: the quenching of metals and the quenching of coke.

In the case of the quenching of metals, the molten metal can be plunged either directly into a cold liquid medium or onto a cooled surface. In the case of a powder, it may be placed in a container, usually made of steel, and transferred, for example using a conveyor, from a zone said to be hot to a zone said to be cold (continuous furnace).

However, the falling of certain powders into the cold liquid medium may cause powder to be splashed into the atmosphere (through the evaporation of the liquid), leading to safety risks, to a lower yield and to inconsistencies in the quality of the product obtained. As far as continuous furnaces are concerned, the use of a metal container (steel, nickel-based alloy, etc.) during the step of increasing the temperature may cause chemical reactions between the powder and the material of the container, thus leading to impurities in the product obtained which are detrimental to certain desired properties such as the electrochemical performance. A material that is inert with respect to the powders is alumina, but alumina is unable to withstand thermal shock and therefore breaks upon quenching. Moreover, it is sometimes necessary to obtain brutal cooling of the powder rather than simple rapid cooling like that obtained with continuous furnaces.

In the case of the quenching of coke, which is a powder, this coke is cooled as it leaves the furnace in a fall during which heat is exchanged with the air (dry process) and/or with water (wet process). However, such a process entails large bulky installations ill-suited to the quenching of limited quantities of material in powder form.

It is an object of the present invention to address the technical problems listed hereinabove. A particular object of the invention is to propose a heat treatment device, and the corresponding method, that allow materials in the form of powder to be quenched simply and safely while at the same time limiting the presence of impurities in the product obtained.

One aspect of the invention proposes a heat treatment device for a material in powder form, comprising a heat treatment furnace having a heating zone, and a quenching tank. The quenching tank comprises a container at least partially filled with a plurality of solid elements, and the heat treatment furnace is mounted so that it is mobile so that the contents of the heat treatment furnace can be transferred to the quenching tank.

Thus, by virtue of the use of a plurality of solid elements (for example balls) rather than a liquid, it is possible to carry out quenching in a container that can have small dimensions, while at the same time limiting any splashing or impurities in the product obtained. In particular, the use of a plurality of solid elements allows the powders to be cooled without the formation of a gaseous phase (which is what causes the splashes in the case of quenching in a liquid). The solid elements are able to withstand temperature differences in excess of 1000° C.

According to the invention, the solid elements are mounted freely in the container. In other words, the solid elements are not fixed to the container.

For preference, the solid elements are cooled beforehand. They may thus be at a temperature of below −10° C., more preferably below −100° C., and more preferably still, below −150° C. The solid elements may for example be cooled by liquid nitrogen, the boiling point of which is close to −200° C.

A plurality preferably means n solid elements, n being comprised between 2 and 100 000, and more preferably comprised between 100 and 10 000. The solid elements may be identical or different.

The largest dimension of the solid elements may be less than 20 cm, preferably less than 10 cm, and more preferably still, less than 3 cm. In particular, in the case of solid elements in the form of balls, the diameter of the balls may be comprised between 0.1 cm and 3 cm, typically between 0.5 cm and 3 cm. A small size notably makes it possible to increase the area for contact between the solid elements and the powder and therefore increase the efficiency of the quench.

Thus, in order to encourage contact between the solid elements and the powder, it is preferable to have a ratio of ball volume to powder volume of between 30 and 1000, preferably between 200 and 700.

For preference, the container is able to be subjected to an agitating movement. The agitating movement may be a rotational movement or a vibrational movement. Thus, the number of solid elements likely to come into contact with the powder material that is to be quenched is increased, as therefore is the cooling area of the solid elements in the quenching tank.

For preference, the quenching tank also comprises a rotational-drive means for rotating the container or a vibrating means. The container may be of cylindrical shape and the rotational-drive means may comprise two rollers connected to a drive motor and on which the container is mounted. The rotational-drive means thus can act both as a means of supporting and as a means of rotating the container.

For preference, the rotational-drive means is able to make the container rotate about an axis that makes an angle of more than 5° with the vertical direction, for example of between 5° and 70°, preferably between 20° and 60°, and more preferably still, between 40° and 50°. The rotational-drive means allows the temperature of the solid elements contained in the container to be evened out, notably by mixing them, and also allows the cooled powder to be deagglomerated, while at the same time achieving optimum dispersion of the powder throughout the container.

For preference, the heat treatment furnace is a tube furnace having a horizontal main axis, the furnace being mounted on a pivoting stand able to incline the axis of the furnace so as to allow the contents of the furnace to be transferred to the quenching tank under gravity.

For preference, when the powder is being transferred into the quenching tank, no additional transfer element is provided such that the powder encounters no solid element other than those provided in the container of the quenching tank. In other words, the transfer of the contents of the furnace into the quenching tank under gravity can be performed directly, with no additional transfer element positioned between the furnace and the quenching tank. The powder can thus drop directly from the furnace into the quenching tank.

For preference, the heating zone of the heat treatment furnace comprises an axial tube made of alumina.

For preference, the solid elements are balls, for example made of steel.

The invention also, in another aspect, relates to a heat treatment method for a material in powder form, in which:
the material is heated, keeping it at a treatment temperature for a determined length of time,
the material is cooled by contact with a plurality of previously cooled solid elements.

More particularly, according to the method, the material is cooled by transferring it into a quenching tank as described hereinabove.

For preference, the plurality of solid elements is cooled by contact with liquid nitrogen. For example, the plurality of solid elements may be cooled beforehand in two stages, by bringing them into contact with liquid nitrogen twice in succession.

In order to do this, the solid elements may be brought into contact with the liquid nitrogen outside of the container of the quenching tank, then introduced into the quenching tank prior to quenching. In a preferred alternative, the liquid nitrogen is added to the container of the quenching tank already containing the solid elements, and the container is rotated to encourage the temperature of the plurality of solid elements to even out.

Of course, prior to quenching, steps are taken to ensure that the liquid nitrogen used for cooling the solid elements is completely evaporated from the container of the quenching tank.

The quantity of liquid nitrogen to be used can easily be determined by a person skilled in the art with reference to the dimensions of the container and of the solid elements.

For preference, the solid elements are rotated in a container or agitated by vibration while the material in powder form is being quenched.

For preference, the cooled material is separated from the solid elements by screening. In that case, provision is made for the powder to have a particle size very much smaller than the size of the solid elements. Usually, the powder has a particle size of between 10 nm and 500 μm, preferably between 10 nm and 100 μm.

Another aspect of the invention proposes an application of the method to the manufacture of the active material of a battery in the form of powder. What is meant in particular by active material is a lithium insertion material.

One particular aspect of the invention proposes the manufacture of lithium-rich lamellar oxide, for example a lithium-rich lamellar manganese nickel magnesium oxide, in which a heat treatment is performed, for example on a mixed lithium manganese nickel magnesium carbonate, using the method described hereinabove.

The lithium-rich lamellar oxide of the lithium-rich manganese nickel magnesium oxide type can be used as positive electrode material for a lithium-ion battery and, more particularly, for applications requiring high energy such as in electric vehicles.

According to one embodiment of the invention, the lamellar-type oxide corresponds to the following general formula:

xLi₂MnO₃(1−x)LiM¹ₐM²_{b}M³_{c}O₂

where:
0<x<1
M¹ is a chemical element selected from a first group consisting of Mn, Ni, Co, Fe, Ti, Cr, V and Cu,
M³ is at least one chemical element selected from a second group consisting of Mg, Zn, Al, Na, Ca, Li, K, Sc, B, C, Si, P and S,
M² is a chemical element selected from the first group and the second group and is different from M¹ and M³,
a+b+c=1, with a, b and c being non-zero.

According to one embodiment, x is equal to 0.75.

The invention finally relates to a battery, notably for a motor vehicle, comprising at least one electrode containing lithium-rich lamellar manganese nickel magnesium oxide formed according to the method described hereinabove.

Other advantages and features of the invention will become apparent from studying the detailed description of one nonlimiting embodiment of the invention, illustrated by the attached FIGURE which schematically depicts a heat treatment device according to the invention.

The attached FIGURE depicts a heat treatment device 1. The device 1 notably comprises a heat treatment furnace 2, a quenching tank 3 and a transfer means 4.

The heat treatment furnace 2 is, for example, a conventional tube furnace: it may comprise a cylindrical heating body 5 with an axis arranged horizontally, a cylindrical side wall and two end faces. The cylindrical body 5 also comprises an axial recess 6, near the axis of the cylindrical body 5. The axial recess 6 may for example go all the way through, with an opening 7 on each end face of the cylindrical body 5. During the heating step, the openings 7 are plugged. The product that is to be heated or a container for the product that is to be heated is positioned inside the recess 6. In this particular case, the heat treatment furnace 2 comprises an alumina tube 8 by way of container, so as to avoid chemical reactions between the material of the container and the powders during the step of increasing the temperature. The alumina tube 8 is mounted fixedly in the heat treatment furnace 2 so as to prevent it from also experiencing a thermal shock.

Finally, the heat treatment furnace 2 also comprises a power supply 9, for example an electrical power supply.

The quenching tank 3 comprises a container 10, for example of cylindrical shape, containing a plurality of solid elements (not depicted) inside. For example, the container 10 may contain steel balls of diameter 1.2 cm. The cylindrical container 2 comprises an opening 11 at the upper face of the cylinder so as to allow the powders from the furnace 2 to drop into the container 10. The quenching tank 3 also comprises a rotational-drive means, for example bars 12 rotationally driven by motorized means (not depicted) and on which the container 10 is placed. The bars 12 on the one hand allow the container 10 with the solid elements inside to be turned, and also allow the container 10 to be kept inclined with respect to the vertical. For example, the bars 12 may keep the container 10 at an angle of 45° between the axis of the container and the vertical.

The heat treatment device 1 finally comprises the transfer means 4 comprising a stand 13 supporting the heat treatment furnace 2 and the quenching tank 3. More specifically, the stand 13 keeps the heat treatment furnace 2 at a height above that of the quenching tank 3, so as to allow the contents of the furnace 2 to be transferred to the quenching tank 3 under gravity. Thus, the furnace 2 is mounted on a horizontal axis 14 perpendicular to the axis of the heat treatment furnace 2. The axis 14 allows the axis of the heat treatment furnace 2 to be inclined (or pivoted). Moreover, the quenching tank 3 is positioned near the heat treatment furnace 2 and the opening 11 is directed in such a way that the opening 7 of the recess 6 of the furnace 2 comes to face the opening 11 when the furnace 2 is pivoted about the axis 14.

In operation, the heat treatment device 1 is prepared in a first stage: the mixture of precursors in powder form is introduced into the alumina heating zone 8 placed inside the furnace 2 in a horizontal position and heated to an adequate temperature for a length of time suited to the heat treatment, for example from 5 to 30 hours depending on the material that is to be heat-treated and according to the general knowledge of those skilled in the art of powders.

Next, liquid nitrogen is poured into the container 10 of the quenching tank 3 in order to cool the balls it contains. Liquid nitrogen may be poured into the container 10 twice in succession, and the bars 12 are rotated so that the balls are all cooled evenly inside the container 10, until the liquid nitrogen is completely evaporated or used up. Immediately thereafter, the furnace 2 is pivoted by the stand into the inclined position so as to cause the opening 7 of the recess to face the opening 11 of the container 10. Under the effect of gravity, the powder slides into the rotating quenching tank 3, in which it is cooled by the balls. The powder is then separated from the balls by screening.

This then provides uniform quenching of the powder and an absence of agglomeration of powder particles.

One example of an application is described hereinafter:

the example relates to the heat treatment and quenching of a material in powder form for the positive electrode of a lithium-ion battery. The material is a lithium-rich lamellar oxide of formula 0.75Li₂MnO₃·0.25LiNi_{0.9}Mn_{0.05}Mg_{0.05}O₂.

A mixture of precursors is selected so as to form a mixed lithium manganese nickel magnesium carbonate. The mixture (approximately 100 grams) is introduced into the alumina tube of the tube furnace in order to be heated.

The quenching tank is filled with 17 457 g of 100C6 steel balls of diameter 12 mm, namely approximately 2537 balls, filling approximately a volume of 5 liters. The volume ratio of balls to powder is approximately 425. The cooling of the balls using the liquid nitrogen is performed in two stages: in a first step, 5 liters of liquid nitrogen are introduced and the container is rotated. The operation is repeated twice at 5-minute intervals in order to cool the balls to their core.

At the end of the heat treatment of the mixture of precursors (temperature of around 1000° C. for a duration of between 10 hours and 24 hours), the furnace is pivoted and the powder slips into the quenching tank to be quenched. The container 10 rotates at a speed of between 15 and 30 revolutions/minute. Quenching lasts approximately 1 minute and the powder can be recovered immediately, after having been separated from the balls by screening.

The material obtained is characterized by x-ray diffraction. It has thus been found that no spinel phase has appeared during the quenching phase, thus making it possible to obtain a product with very good electrochemical performance.

Thus, by virtue of the quenching tank described hereinabove it is possible, using small installations and without splashing into the atmosphere, to perform a quenching step that limits the appearance of additional crystalline phases in the form of impurities in the end-product obtained.

1-13. (canceled)

14. A heat treatment device for a material in powder form, comprising:
a heat treatment furnace having a heating zone; and
a quenching tank comprising a container at least partially filled with a plurality of solid elements; and
wherein the heat treatment furnace is mounted configured to be mobile so that contents of the heat treatment furnace can be transferred to the quenching tank.

15. The heat treatment device as claimed in claim 14, further comprising a rotational-drive means for rotating the container or a vibrating means.

16. The heat treatment device as claimed in claim 15, wherein the container is of cylindrical shape and the rotational-drive means comprises two rollers connected to a drive motor and on which the container is mounted.

17. The heat treatment device as claimed in claim 15, wherein the rotational-drive means is configured to make the container of the quenching tank rotate about an axis that makes an angle of more than 5° with the vertical direction.

18. The heat treatment device as claimed in claim 14, wherein the heat treatment furnace is a tube furnace having a horizontal main axis, the furnace being mounted on a pivoting stand configured to incline the axis of the furnace to allow contents of the furnace to be transferred to the quenching tank under gravity.

19. The heat treatment device as claimed in claim 14, wherein a heating zone of the heat treatment furnace comprises an axial tube made of alumina.

20. The heat treatment device as claimed in claim 14, wherein the solid elements are balls, or are made of steel.

21. A heat treatment method for a material in powder form, comprising:
heating the material, keeping the material at a treatment temperature for a determined length of time;
cooling the material by contact with a plurality of previously cooled solid elements.

22. The heat treatment method as claimed in claim 21, wherein the plurality of solid elements is cooled by contact with liquid nitrogen.

23. The heat treatment method as claimed in claim 21, wherein the solid elements are rotated in a container or agitated by vibration while the material in powder form is being quenched.

24. The heat treatment method as claimed in claim 21, wherein the cooled material is separated from the solid elements by screening.

25. An application of a method to manufacture of lithium-rich lamellar oxide, or a lithium-rich lamellar manganese nickel magnesium oxide, wherein a heat treatment is performed, or is performed on a mixed lithium manganese nickel magnesium carbonate, as claimed in claim 21.

26. A battery, or a battery for a motor vehicle, comprising at least one electrode containing lithium-rich lamellar oxide formed as claimed in claim 25.
